(19) United States
(12) Patent Application Publication
(10) Pub. No.: US 2024/0009719 A1
(43) Pub. Date: Jan. 11, 2024

(54) METHOD FOR OPENING AN ELECTROCHEMICAL GENERATOR

(71) Applicants: COMMISSARIAT À L'ÉNERGIE ATOMIQUE ET AUX ÉNERGIES ALTERNATIVES, Paris (FR); ORANO, Chatillon (FR)

(72) Inventor: Emmanuel Billy, Grenoble (FR)

(21) Appl. No.: 18/248,173

(22) PCT Filed: Oct. 5, 2021
(86) PCT No.: PCT/FR2021/051723

§ 371 Date: Apr. 6, 2023

(30) Foreign Application Priority Data
Oct. 9, 2020 (FR) 2010323

(51) Int. Cl. B09B 3/70; H01M 6/52; H01M 10/54; B09B 3/35

(52) U.S. Cl. CPC B09B 3/70; H01M 6/52; H01M 10/54; B09B 3/35; B09B 2101/16

(57) ABSTRACT

A method for securing an electrochemical generator comprising a negative electrode containing lithium or sodium and a positive electrode, the method comprising the following successive steps: a) immersing an electrochemical generator, in an ionic liquid solution comprising a solvent ionic liquid and, possibly, a so-called oxidant redox species able to be reduced on the negative electrode so as to discharge the electrochemical generator, b) opening the electrochemical generator with an electrically-insulating element, opening being carried out in the ionic liquid solution.

### TECHNICAL FIELD

The present invention relates to a method for opening an electrochemical generator, such as an accumulator or a Li-Ion, Na-Ion, or Lithium-metal battery, in particular for recycling and/or storage thereof.

The electrochemical generator can be safely opened and the recoverable fractions can be recycled.

The invention is particularly interesting for recycling of accumulator or cell type electrochemical systems treated separately or as a mixture.

### PRIOR ART

An electrochemical generator is an electric power production device converting chemical energy into electrical energy. For example, it may consist of cells or accumulators.

The market for accumulators, and in particular lithium accumulators, of the Li-ion type, is currently expanding rapidly, on the one hand, because of so-called nomadic applications (smartphone, computer, camera, . . . ) and, on the other hand, because of new applications related to mobility (electric and hybrid vehicles) and so-called stationary applications (connected to the power grid).

Because of the growing number of accumulators in recent years, the question of recycling thereof has therefore become a major issue.

Conventionally, a lithium-ion accumulator comprises an anode, a cathode, a separator, an electrolyte and a case.

In general, the anode is formed from graphite mixed with a PVDF type binder deposited over a copper sheet and the cathode is a metallic lithium insert material (for example, LiCoO₂, LiMnO₂, LiNiO₂, LiNixCo₁₋ₓO₂ with 0<x<1, Li₃NiMnCoO₆, or LiFePO₄) mixed with a binder and deposited over an aluminium sheet.

The electrolyte is a mixture of non-aqueous solvents and lithium salts, and possibly additives to slow down secondary reactions.

The operation is as follows: during charging, the lithium deintercalates from the metal oxide and intercalates into the graphite, where it is thermodynamically unstable. During discharge, the process is reversed and the lithium ions are intercalated in the lithium metal oxide.

As it is used, ageing leads to a loss of capacity and the cell must be recycled.

However, a large number of accumulators or accumulator batteries to be recycled are still at least partially charged and grinding thereof produces sparks and significant ignitions and even explosions, in particular with primary lithium batteries (Li—SOCl₂).

Damaged cells must also be recycled. However, these cells may have metallic lithium deposits on the anode, which are very reactive when exposed to air or water.

Hence, end-of-life and/or damaged cells to be recycled must be handled with the utmost caution.

Conventionally, the accumulator recycling method comprises several steps:
a pre-processing step including a dismantling phase and a securing phase,
thermal and/or hydrometallurgical treatments to recover the different recoverable materials and metals contained in these cells and accumulators.

To date, the main problem lies in the phase of securing and opening these lithium-based electrochemical systems (primary and secondary).

Indeed, upon loss of containment, electrolyte, a toxic, flammable and corrosive product, in liquid form but also gaseous leaks occur. The vapours thus generated and mixed with air can then form an explosive atmosphere (ATEX). The latter could ignite on contact with a spark-type ignition source or a hot surface. This then results in an explosion causing thermal effects and pressure effects. In addition, electrolyte salts such as lithium hexafluorophosphate LiPF₆, lithium tetrafluoborate LiBF₄, lithium perchlorate LiClO₄, lithium hexafluoroarsenate LiAsF₆ could release particularly toxic and corrosive fumes containing phosphorus, fluorine and/or lithium. For example, there might be the formation of hydrofluoric acid (HF) during the thermal degradation of Li-ion batteries.

To overcome these drawbacks, it is possible to grind the batteries in a chamber with a controlled atmosphere and pressure. As example, the document WO 2005/101564 A1 describes a method for recycling a lithium anode battery by hydrometallurgical means, at room temperature and under an inert atmosphere. The atmosphere comprises argon and/or carbon dioxide. The two gases will expel the oxygen and form a protective headspace above the crushed load. The presence of carbon dioxide will lead to the initiation of passivation of metallic lithium by formation of lithium carbonate at the surface, which slows down the reactivity of this metal. The hydrolysis of the ground load containing lithium leads to the formation of hydrogen. To avoid the risks of ignition of the hydrogen and of explosion, the ground load containing lithium is added in a very controlled manner in the aqueous solution and a very strong turbulence above the bath is created. This operation is associated with a depletion of the atmosphere in oxygen. The water becomes rich in lithium hydroxide and lithium is recovered by addition of sodium carbonate or phosphoric acid.

In the method of the patent U.S. Pat. No. 5,888,463, securing the batteries and accumulators is carried out by a cryogenic process. The cells and accumulators are frozen in liquid nitrogen at −196° C. before being crushed. Afterwards, the ground matter is immersed in water. To avoid the formation of H₂S, the pH is maintained at a pH of at least 10 by addition of LiOH. The formed lithium salts (Li₂SO₄, LiCl) are precipitated in the form of carbonate by addition of sodium carbonate.

The document CA 2 313 173 A1 describes a method for recycling lithium ion cells. The cells are cut beforehand in a water-free inert atmosphere. A first organic solvent (acetonitrile) allows dissolving the electrolyte and a second organic solvent (NMP) allows dissolving the binder. Afterwards, the particulate insert material is separated from the solution and reduced by electrolysis.

In the document WO 2011/113860 A1, a so-called dry method (“Dry-Technology”) is described. The temperature of the grinder is maintained between 40 and 50° C. and the mixture of hydrogen and oxygen, released from the batteries, is eliminated, by a cyclonic air movement, to minimise the risk of fire outbreak. The pieces of battery and dust, recovered after sieving, are cooled down to room temperature. The extraction of lithium seems to be done by reaction with oxygen and humidity in the air, causing risks related to the simultaneous presence of hydrogen, oxygen and heat conducive to combustion and explosion. Moreover, grinding of these accumulators causes crushing and short circuits which can lead to an explosion. In addition, the electrolyte is degraded, generating risks, losses and difficulties with regards to the management of dust and gases.

The UmiCore VAL'EAS™ process, described in the article by Georgi-Maschler et al. (“Development of a recycling process for Li-ion batteries” Journal of Power Sources 207 (2012) 173-182) combines pyrometallurgical and hydrometallurgical treatments. The dismantled batteries are directly introduced into a furnace. The pyrometallurgical treatment allows deactivating them: the electrolyte evaporates at almost 300° C.; the plastics are pyrolised at 700° C. and the remainder is finally melted and reduced at 1,200-1,450° C. A portion of the organic matters contained in the cells serves as a reductant agent in the process. Aluminium and lithium are lost. Iron, copper, and manganese are recovered in an aqueous solution. Cobalt and nickel are recovered as LiCoO₂ and Ni(OH)₂ and recycled to form cathode materials. However, this type of heat treatment generates high energy consumption and leads to a considerable degradation of the components of the battery.

The document EP 0 613 198 A1 describes a method for recovering materials derived from lithium cells. The cells are cut either under a high-pressure water jet or under an inert atmosphere to avoid an outbreak of fire. Then, the lithium reacts with water, an alcohol or an acid to form, respectively, lithium hydroxide, a lithium alkoxide or a lithium salt (LiCl, for example). However, the securing procedure carried out with high-pressure water jet cutting requires high water consumption and generates H₂ gases in air.

To date, the different methods for opening the above-described cells/batteries require high temperature treatments, cryogenic treatments, and/or under controlled atmosphere, which are conditions that are difficult to industrialise and/or expensive.

### DISCLOSURE OF THE INVENTION

The present invention aims to propose a method allowing overcoming the drawbacks of the prior art, and in particular a method allowing opening an electrochemical generator in full safety, the method having to be easily industrialised.

This aim is achieved by a method for opening an electrochemical generator comprising a negative electrode containing lithium or sodium and a positive electrode possibly containing lithium or sodium, the method comprising the following successive steps:
immersing the electrochemical generator, in an ionic liquid solution comprising a solvent ionic liquid and, possibly, a so-called oxidant redox species able to be reduced on the negative electrode so as to discharge the electrochemical generator,
b) opening the electrochemical generator with an electrically-insulating element, opening being carried out in the ionic liquid solution.

The invention differs fundamentally from the prior art by the implementation of the step of opening the electrochemical generator, in an ionic liquid solution. Ionic liquids are non-volatile, non-flammable and chemically stable at temperatures that may be higher than 200° C. (for example between 200° C. and 400° C.). The ionic liquid solution is a non-reactive medium enabling the controlled and secure opening of the electrochemical generator while avoiding violent reactions with water and/or air.

Opening is ensured by an element which is not electrically conductive, so as to avoid an electrical short-circuit and avoid the generation of too sudden a discharge between the positive and negative elements of the electrochemical generator.

Preferably, the ionic liquid solution comprises a redox species capable of reacting with the lithium or the sodium of the negative electrode (anode). Opening of the electrochemical generator allows access to lithium: the chemical species completes the action of discharging by oxidation-reduction with lithium (or sodium). This reactive species discharges the electrochemical generator during opening, which further avoids the risk of ignition and/or explosion. During this discharge process, the ionic liquid promotes cooling of the medium and allows evacuating the calories. This preferred embodiment simultaneously leads to opening and securing of the electrochemical generator.

By able to be reduced on the negative electrode, it should be understood that the active species can react either directly on the negative electrode (anode), in the case where the case of the accumulator is open, or on another element electrically connected to the anode, such as the anode current collector, the terminal of the anode or the ground when the anode is electrically connected to the ground.

Next, when lithium is described, lithium may be replaced by sodium.

For example, in the case of a lithium-metal accumulator, the reduction reaction of the so-called oxidant redox species leads to the oxidation of the metallic lithium in ionic form.

According to another example, in the case of a lithium-ion accumulator, the reduction reaction of the so-called oxidant redox species leads to the deinsertion of the lithium ion from the active material of the negative electrode.

The free ions extracted from the anode, migrate through the ion-conductive electrolyte and are immobilised in the cathode where they form a thermodynamically stable lithium oxide. By thermodynamically stable, it should be understood that the oxide does not react violently with water and/or air.

Advantageously, the solution comprises a second so-called reductant redox species able to be oxidised on the positive electrode, the so-called oxidant redox species and the so-called reductant redox species forming a pair of redox species.

By redox pair, also called redox mediator or electrochemical shuttle, it should be understood an oxidant/reductant (Ox/Red) pair in solution whose oxidant can be reduced on the anode (negative electrode) and the reductant can be oxidised on the cathode (positive electrode). The oxidation of the reductant and the reduction of the oxidant allow forming new oxidant/reductant species and/or regenerating the species initially present in solution. The method is economical since the redox pair in solution ensures at the same time and simultaneously the redox reactions at the electrodes/terminals of the electrochemical generator, so that the consumption of reagent is zero; the solution can be used to secure several electrochemical generators successively and/or in a mixture.

The redox species allow(s) discharging the electrochemical generator significantly and possibly completely. In addition, when the electrochemical generator is opened, they will react with the internal components, so as to reduce the potential difference between the electrodes (anode and cathode). This internal discharge also participates in securing the electrochemical generator by reducing the chemical energy of the electrodes (and therefore the potential difference) and by reducing the internal short-circuit effect.

The absence of water allows avoiding the generation of hydrogen, the main obstacle to the use of aqueous extinguishing agents which could generate explosive atmospheres.

Advantageously, the pair of redox species is a metallic pair, preferably selected from among Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, a pair of organic molecules, a pair of metallocenes such as Fc/Fc⁺, or a pair of halogenated molecules like for example Cl₂/Cl⁻ or Cl⁻/Cl₃⁻.

Advantageously, the ionic liquid solution comprises an additional ionic liquid.

Advantageously, the ionic liquid solution forms a deep eutectic solvent.

According to a first advantageous variant, opening of the electrochemical generator (step b)) is carried out under air.

According to a second advantageous variant, opening of the electrochemical generator (step b)) is carried out under an inert atmosphere allowing control of the oxygen content. Thus, the whole is secured (with regards to the triangle of fire). The method is not a thermal process and allows managing the step of opening the

electrochemical accumulator. Advantageously, it may be carried out at room temperature (20-25° C.).

Optionally, the ionic liquid solution may be stirred and/or cooled. It is also possible to add to the ionic liquid solution species with advantageous calorific capacities promoting cooling.

Opening of the generator is done by an electrically-insulating element. The electrically-insulating element may be part of a tool. By tool, it should be understood a tool that can pierce, grind and/or cut. At least the portion of the tool that penetrates into the electrochemical generator is not electrically conductive. Preference will be given to technologies that do not lead to an excessive deformation (crushing) in order to avoid short circuits. Non-exhaustively, opening may be done by cutting, sawing, abrasion. Preferably, the tool allows cutting the electrochemical generator partially or completely. The electrically-insulating element used to open the electrochemical generator may be a blade, for example a guillotine-type blade, a circular blade or a band saw, cutting wires, knives, ultrasounds, a liquid jet provided with or devoid of electrically-insulating abrasive particles or a gas jet containing electrically-insulating abrasive particles. For example, the electrically-insulating abrasive particles may be made of silicate.

According to a first advantageous embodiment, the electrically-insulating element is a blade, for example made of ceramic.

According to a second advantageous embodiment, the electrically-insulating element is an ionic liquid jet comprising electrically-insulating abrasive particles enabling the abrasion and opening of the electrochemical generator.

Advantageously, the method comprises, prior to step a), a dismantling step and/or a sorting step.

Advantageously, the method comprises, subsequent to step b), a storage step and/or a pyrometallurgical and/or hydrometallurgical step.

The opening method according to the invention has many advantages:

Implementing the opening step in an ionic liquid thereby avoiding a violent reaction with water and/or air, which not only avoids problems related to the management of hydrogen, oxygen and heat, and therefore to the management of an explosive atmosphere (safety, treatment of affluents, additional economic cost), but also the use of large volumes of water and therefore the treatment of aqueous effluents.

Using no heat treatment, which avoids problems related to the emission of gases (for example greenhouse gases or any other harmful and dangerous gas for humans and the environment) and treatment thereof, which reduces the financial and energy costs of the method.

Being safe and simple to implement.

In addition, in the case where the ionic liquid solution comprises a chemical species ensuring the extraction of lithium (or sodium), the method also has the following advantages:

Simultaneously opening and securing the electrochemical generator; yet, opening of the electrochemical generators is essential for the recycling of its constituent elements; such a coupling allowing saving significant time and investment.

Allowing direct access between the lithium and the active species, and therefore being able to carry out a quick discharge (typically a discharge in less than 10 h and preferably less than 3 h).

Being able to use a wide selection of active species, the active species having just to have an electrochemical potential higher than that of lithium (lithium is the species with the lowest electrochemical potential and can therefore be extracted with any species capable of being reduced to a potential higher than −3.05V vs. ENH).

Being able to treat damaged cells and/or batteries that cannot be discharged before opening (for example due to mechanical degradation or corrosion of the terminals).

Other features and advantages of the invention will become apparent from the following complementary description.

It goes without saying that this additional description is provided solely for the purpose of illustrating the object of the invention and must not be interpreted as constituting a limitation thereto in any way.

### BRIEF DESCRIPTION OF THE DRAWINGS

The present invention will be better understood upon reading the description of embodiments given for merely informative and in no way limiting purposes with reference to the appended drawings wherein:

FIG. 1 schematically represents a sectional view of a lithium-ion accumulator, according to a particular embodiment of the invention.

FIG. 2 is a photographic negative representing a cell opened with a blade made of ceramic in Ethaline medium, according to a particular embodiment of the invention.

The different portions represented in the figures are not necessarily plotted on a uniform scale, to make the figures more readable.

### DETAILED DISCLOSURE OF PARTICULAR EMBODIMENTS

Next, even though the description refers to a Li-ion accumulator, the invention can be transposed to any electrochemical generator, for example to a battery comprising several accumulators (also called accumulator batteries), connected in series or in parallel, depending on the nominal operating voltage and/or the amount of energy to be supplied, or to an electric cell.

The safety method concerns all accumulator or cell type electrochemical systems treated separately or as a mixture.

These different electrochemical devices can be of the metal-ion type, for example lithium-ion or sodium-ion, or else of the Li-metal type, . . .

It may also consist of a primary system such as Li/MnO₂, or else a flow battery (“Redox Flow Battery”).

Advantageously, an electrochemical generator having a potential greater than 1.5V will be selected.

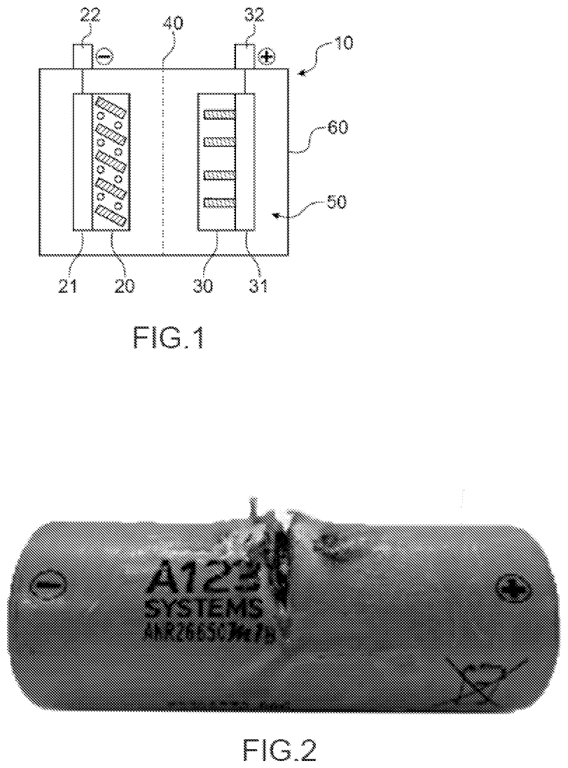

First, reference is made to FIG. 1 which represents a lithium-ion (or Li-ion) accumulator 10. A single electrochemical cell is represented but the generator may comprise several electrochemical cells, each cell comprising a first electrode 20, herein the anode, and a second electrode 30, herein the cathode, a separator 40 and an electrolyte 50. According to another embodiment, the first electrode 20 and the second electrode 30 could be reversed.

Preferably, the anode (negative electrode) 20 is carbon-based, for example, made of graphite which can be mixed with a PVDF type binder and deposited over a copper sheet. It may also consist of a lithium mixed oxide like lithium titanate Li₄Ti₅O₁₂ (LTO) for a Li-ion accumulator or a sodium mixed oxide like sodium titanate for a Na-Ion accumulator. It could also consist of a lithium alloy or a sodium alloy depending on the selected technology.

The cathode (positive electrode) 30 is a lithium ion insert material for a Li-ion accumulator. It may consist of a LiMO₂ type lamellar oxide, a phosphate LiMPO₄ with an olivine structure or a spinel compound LiMn₂O₄ and wherein M represents a transition metal. For example, a positive electrode made of LiCoO₂, LiMnO₂, LiNiₓCo₁₋ₓO₂ (with 0<x<1), LiNiO₂, Li₃NiMnCoO₆, or LiFePO₄ will be selected.

The cathode (positive electrode) 30 is a sodium ion insert material for a Na-ion accumulator. It may consist of a sodium oxide type material comprising at least one transition metal element, a sodium phosphate or sulphate type material comprising at least one transition metal element, a sodium fluoride type material, or a sulphide type material comprising at least one transition metal element.

The insert material can be mixed with a binder of the polyvinylidene fluoride type and deposited over an aluminium sheet.

The electrolyte 50 includes lithium salts (LiPF₆, LiBF₄, LiClO₄ for example) or sodium salts (N₃Na for example), depending on the selected accumulator technology, dissolved in a mixture of non-aqueous solvents. For example, the mixture of solvents is a binary or ternary mixture. For example, the solvents are selected from among solvents based on cyclic carbonates (ethylene carbonate, propylene carbonate, butylene carbonate), linear or branched (dimethyl carbonate, di-ethyl carbonate, ethyl methyl carbonate, dimethoxyethane) in various proportions.

Alternatively, it could also consist of a polymer electrolyte comprising a polymer matrix, made of an organic and/or inorganic material, a liquid mixture comprising one or more metal salt(s), and possibly a mechanical reinforcement material. The polymer matrix may comprise one or more polymer material(s), for example selected from among a polyvinylidene fluoride (PVDF), a polyacrylonitrile (PAN), a polyvinylidene fluoride hexafluoropropylene (PVDF-HFP), or a poly(ionic liquid) of the poly(N-vinylimidazolium)bis(trifluoromethanesulfonylamide)), N,N-diethyl-N-(2-methoxyethyl)-N-methylammonium bis(trifluoromethylsulfonyl)imide (DEMM-TFSI) type.

The cell may be wound on itself around a winding axis or have a stacked architecture.

A case 60 (“casing”), for example a pocket made of polymer, or a metal packaging, for example made of steel, allows ensuring tightness of the accumulator.

Each electrode 20, 30 is connected to a current collector 21, 31 passing through the case 60 and forming, outside the case 60, the terminals 22, 32 respectively (also called output terminals or electrical poles or terminals). The function of the collectors 21, 31 is dual: to ensure mechanical support for the active material and electrical conduction up to the terminals of the cell. The terminals, also called electrical poles or terminals, form the output terminals and are intended to be connected to an “energy receiver”.

According to some configurations, one of the terminals 22, 32 (for example that one connected to the negative electrode) can be connected to the ground of the electrochemical generator. It is then said that the ground is the negative potential of the electrochemical generator and that the positive terminal is the positive potential of the electrochemical generator. Hence, the positive potential is defined as the positive pole/terminal as well as all metallic parts connected by electrical continuity from this pole.

An intermediate electronic device may possibly be disposed between the terminal that is connected to ground and the latter.

The method for opening the electrochemical generator 10 comprises the following steps:
immersing the electrochemical generator 10 in an ionic liquid solution comprising an ionic liquid and, preferably, a redox species able to react with the lithium so as to neutralise it, then
opening the electrochemical generator 10 with an electrically-insulating element.

The ionic liquid solution 100 comprises at least one ionic liquid LI₁, called solvent ionic liquid.

By ionic liquid, it should be understood the association comprising at least one cation and one anion which generates a liquid with a melting point lower than or close to 100° C. For example, these consist of molten salts.

By “solvent ionic liquid”, it should be understood an ionic liquid that is thermally and electrochemically stable, minimising an effect of degradation of the medium during the discharge phenomenon.

The ionic liquid solution 100 may also comprise an additional ionic liquid denoted LI₂ or several (two, three, . . . ) additional ionic liquids, i.e. it comprises a mixture of several ionic liquids.

By “additional ionic liquid”, it should be understood an ionic liquid that promotes one or more propert(y/ies) with regards to the securing and discharge step. In particular, it may consist of one or more of the following properties: extinction, flame retardant intended to prevent a thermal runaway, redox shuttle, salt stabiliser, viscosity, solubility, hydrophobicity, conductivity.

Advantageously, the ionic liquid, and possibly, the additional ionic liquids are liquid at room temperature (from 20 to 25° C.).

For the solvent ionic liquid and for the additional ionic liquid(s), the cation is preferably selected from among the family: imidazolium, pyrrolidinium, ammonium, piperidinium and phosphonium.

Advantageously, a cation with a wide cationic window will be selected, wide enough to consider a cathodic reaction avoiding or minimising the degradation of the ionic liquid.

Advantageously, LI₁ and LI₂ will have the same cation to increase the solubility of LI₂ in LI₁.

Advantageously, anions allowing simultaneously obtaining a wide electrochemical window, a moderate viscosity, a low melting temperature (liquid at room temperature) and a good solubility with the ionic liquid and the other species of the solution will be used, while that not leading to the hydrolysis (degradation) of the ionic liquid.

The TFSI anion is an example that meets the aforementioned criteria for numerous associations with, for example, for LI₁: [BMIM][TFSI], or the use of a [P66614][TFSI] type ionic liquid, the ionic liquid 1-ethyl-2,3-trimethyleneimidazolium bis(trifluoromethanesulfonyl)imide ([ETMIm][TFSI]), the ionic liquid N,N-diethyl-N-methyl-N-2-methoxyethyl ammonium bis(trifluoromethylsulfonyl)amide [DEME][TFSA], the ionic liquid N-methyl-N-butylpyrrolidinium bis(trifluoromethylsulfonyl)imide ([PYR14][TFSI]), the ionic liquid N-methyl-N-propylpiperidinium bis(trifluoromethanesulfonyl)imide (PP13-TFSI).

The anion may also be of the bis(fluorosulfonyl)imide (FSA or FSI) type, like the ionic liquid N-methyl-N-propylpyrrolidinium FSI (P13-FSI), N-methyl-N-propylpiperidinium FSI (PP13-FSI), 1-ethyl-3-methylimidazolium FSI (EMI-FSI), etc . . .

Advantageously, the anion of the solvent ionic liquid LI₁ and/or the anion of the additional ionic liquid LI₂ may be provided with a complexing anion to form a complex with the electrochemical shuttle.

Other associations may be considered, with ionic liquids (LI₁) whose cation will be associated with an anion which will be either organic or inorganic, preferably having a wide anodic window.

In the numerous possible systems, preference will be given to a non-toxic low-cost medium with low environmental impact (biodegradability). Toxicity and biodegradability are related to those of their components. Thus, one would look for media that have a high biodegradability and that are considered as non-toxic and even able to be used as a food additive.

Advantageously, the ionic liquid solution forms a deep eutectic solvent (or DES standing for “deep eutectic solvents”). It consists of a liquid mixture at room temperature obtained by forming a eutectic mixture of 2 salts, of general formula [Cat]⁺·[X]⁻·z[Y]
with:
[Cat]⁺ is the cation of the solvent ionic liquid (for example ammonium),
[X]⁻ the halide anion (for example Cl⁻),
[Y] a Lewis or Bronsted acid which can be complexed by the anion X⁻ of the solvent ionic liquid, and
z the number of molecules Y.

Eutectics can be divided into three categories depending on the nature of Y.

The first category corresponds to a type I eutectic:
Y=MClₓ for example with M=Fe, Zn, Sn, Fe, Al, Ga

The second category corresponds to a type II eutectic:
Y=MClx·yH₂O for example with M=Cr, Co, Cu, Ni, Fe

The third category corresponds to a type III eutectic:
Y=RZ for example with Z=CONH₂, COOH, OH.

For example, DES is choline chloride associated with an H-bond donor with a very low toxicity, like glycerol or urea, which guarantees a non-toxic and very low-cost DES.

According to another embodiment, choline chloride may be replaced by betaine. Even though these systems have a limited window of electrochemical stability, they allow guaranteeing flooding and deactivation of an accumulator possibly open.

Advantageously, a compound “Y” which can serve as an electrochemical shuttle, which can be oxidised and/or reduced, will be selected. For example, Y is a metal salt, which can be dissolved in the ionic liquid solution so as to form metal ions. For example, Y contains iron.

For illustration, it is possible to form an eutectic between an ionic liquid with a chloride anion and metal salts FeCl₂ and FeCl₃ for different proportions and with different cations.

It is also possible to carry out this type of reaction with type II eutectics which integrate water molecules into the metallic salts when the water proportion is low. Typically, by low, it should be understood less than 10% by weight of the solution, for example from 5 to 10% by weight of the solution.

It is also possible to use type III eutectics which associate the ionic liquid and hydrogen bond donor species (Y), with a [LI₁]/[Y] type mixture where LI₁ may be a quaternary ammonium and Y a complexing molecule (hydrogen bond donor) such as urea, ethylene glycol, thiourea, etc . . .

It is also possible to make a mixture which will advantageously modify the properties of the solution for the discharge of the medium. In particular, it is possible to associate a solvent ionic liquid of the [BMIM][NTF₂] type, which is very stable and liquid at room temperature, but which weakly solubilises the electrochemical shuttle (or redox mediator), such as an iron chloride, with an additional ionic liquid (LI₂)

For example, it is possible to associate an additional ionic liquid LI₂ of the [BMIM][Cl] type which will promote the solubilisation of a metal salt in the form of a chloride by complexation with the anion of LI₂. This allows simultaneously having good transport properties, good solubility of the redox mediator and therefore promoting the discharge phenomenon.

Preferably, the ionic liquid solution also comprises a redox species (also called redox mediator), allowing securing (discharging) the electrochemical generator 10 during and after opening thereof. For example, the redox species is an ion or a species in solution which can be oxidised on the negative electrode 20, or on the terminal 22 connected to the negative electrode 20.

The ionic liquid solution, also called ionic liquid solution, not only prevents contact between the waste (cells or accumulators)/water/air but can also ensure discharge of the waste through the electrochemical redox species present in the ionic liquid. Hence, the set is secured against the fire triangle (oxidant, fuel, energy), avoiding/or minimising the presence of water at the origin of the formation of an explosive atmosphere (H₂, O₂ gas with heat).

By discharge, it should be understood that the method allows significantly reducing the electric charge of the electrochemical generator 10, by at least 50% and preferably by at least 80%, and possibly completely discharging the electrochemical generator (100%). The discharge rate depends on the initial state-of-charge.

Preferably, the electrochemical generator 10 is completely discharged. The free ions are immobilised in the cathode 30, where they form a thermodynamically stable metal-lithium oxide which does not react violently with water or air. This is done at low environmental and economic cost. In addition, the treatment is compatible with the recycling of the different components of the electrochemical generator 10 (in particular the electrolyte is not degraded). The discharge time will be estimated according to the nature of the cells and accumulators and the charge rate.

In particular, the method allows extracting the lithium of the negative electrode to make the accumulator non-reactive to air.

The use of an electrochemical shuttle allows making the device operate in a closed loop. It may consist of an electrochemical pair or association thereof. Preferably, it consists of a redox pair serving as an electrochemical shuttle (or redox mediator) to reduce the degradation of the medium, by ensuring the redox reactions.

By redox pair, it should be understood an oxidant and a reductant in solution capable of being, respectively, reduced and oxidised on the electrodes/terminals of the batteries. The oxidant and the reductant may be introduced in an equimolar or non-equimolar proportion.

The redox pair may be a metal electrochemical pair or one of their associations: Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

In the case where the electrochemical generator is opened, one of the redox species may originate from the generator itself. In particular, it consists of cobalt, nickel and/or manganese.

The redox species and the redox pair may also be selected from among organic molecules, and in particular from among: 2,4,6-tri-t-butylphenoxyl, nitronyl nitroxide/2,2,6,6-tetramethyl-1-piperidinyloxy (TEMPO), tetracyanoethylene, tetramethylphenylenedi-a mine, dihydrophenazine, aromatic molecules for example having a methoxy group, an N,N-dimethylamino group such as methoxybenzene anisole, dimethoxybenzene, or else an N,N-dimethylaniline group such as N,N-dimethylaminobenzene. Mention may also be made of 10-methyl-phenothiazine (MPT), 2,5-di-tert-butyl-1,4-dimethoxybenzene (DDB) and 2-(pentafluorophenyI)-tetrafluoro-1,3,2-benzodioxaborole (PFPTFBDB).

It may also consist of the family of metallocenes (Fc/Fc+, Fe(bpy)₃(ClO₄)₂ and Fe(phen)₃(ClO₄)₂ and derivatives thereof) or the family of halogenated molecules (Cl₂/Cl⁻, Cl⁻/Cl₃₋, Br₂/Br⁻, I₂/I⁻, I⁻/I₃⁻).

In particular, a bromide or a chloride will be selected. Preferably, it consists of a chloride, which can easily complex metals. For example, iron, complexed by the chloride anion, forms FeCl₄⁻ which can decrease the reactivity of the negative electrode.

It may also consist of tetramethylphenylenediamine.

It will also be possible to associate several redox pairs, wherein metals of the metal ions of which are identical or different.

For example, Fe²⁺/Fe³⁺ and/or Cu⁺/Cu²⁺ will be selected. These are soluble in their two oxidation states, they are not toxic, they do not degrade the ionic liquid and they have adequate redox potentials to extract the lithium in the case where the cell is opened. It will also be possible to select the V²⁺/V³⁺ and V⁴⁺/V⁵⁺ combination.

The solution may include one or more so-called “active” species, for example an extinguishing agent and/or a flame retardant intended to prevent thermal runaway, in particular upon opening of the accumulator. It may consist of an alkyl phosphate, possibly fluorinated (fluorinated alkyl phosphate), like trimethyl phosphate, triethyl phosphate, or tris (2,2,2-trifluoroethyl) phosphate). The concentration of active species may be comprised between 5% and 80% by weight, preferably comprised between 30% and 10% by weight.

Optionally, the ionic liquid solution may comprise a desiccant agent, and/or an agent promoting the transport of matter, and/or a protective agent which is a stabiliser/reductant of corrosive and toxic species such as PF₅, HF, POF₃, . . .

For example, the agent promoting the transport of matter is a fraction of a co-solvent added to reduce the viscosity of the medium.

Preferably, an organic solvent will be selected in order to act effectively without generating any discharge or flammability risks. It may consist of vinylene carbonate (VC), gamma-butyrolactone (γ-BL), propylene carbonate (PC), poly(ethylene glycol), dimethyl ether. Advantageously, the concentration of the agent promoting the transport of matter ranges from 1% to 40% and more advantageously from 10% to 40% by weight.

For example, the protective agent capable of reducing and/or stabilising corrosive and/or toxic elements is a compound of the butylamine type, a carbodiimide (N,N-dicyclohexylcarbodiimide type), N,N-diethylamino trimethyl-silane, tris(2,2,2-trifluoroethyl) phosphite (TTFP), an amine-based compound like 1-methyl-2-pyrrolidinone, a fluorinated carbamate or hexamethyl-phosphoramide. It may also be a compound from the cyclophosphazene family like hexamethoxycyclotriphosphazene.

Opening of the electrochemical generator is done with an electrically-insulating element. The electrically-insulating element allows opening the electrochemical generator completely or partially. Opening may be obtained by drilling, by grinding or by cutting. The technologies to be favoured are technologies that avoid excessive deformation (crushing) which would lead to a short circuit.

The electrically-insulating element may be part of a cutting tool (also called carving tool). The cutting tool comprises at least one electrically-insulating portion intended to be in contact with the interior of the electrochemical generator.

As a non-limiting illustration, mention may be made of tools comprising cutting blades, for example guillotine-type blades, sawing blades, for example circular blades or band saws, cutting wires or knives.

Opening of the electrochemical generator may also be carried out by cutting with ultrasounds, by laser beam, by drilling, or else by abrasion with a liquid jet (comprising, preferably, non-conductive abrasive particles).

Preferably, the liquid jet is an ionic liquid jet.

Alternatively, the liquid may be an ionic non-conductive liquid. Preference will be given to a component of the discharge liquid like, for example, a polyol (such as ethylene glycol). Mention may also be made of solvents like 2-Octanone, OctCO2Me, AcOBu, AcOHex or amide-type bio-based solvents (for example, N,N-dimethyldecanamide or N,N-dimethyldec-9-enamide).

The method may be carried out under an inert atmosphere, for example under argon, carbon dioxide, nitrogen or a mixture thereof.

The method may be implemented at temperatures ranging from 5° C. to 80° C., preferably from 20° C. to 60° C. and even more preferably it is implemented at room temperature (20-25° C.).

The ionic liquid solution may be cooled to remove calories during the discharge process.

The ionic liquid solution may be stirred to improve the reactant supply and/or to improve cooling.

The opening method allows cutting the electrochemical generator in complete safety for recycling thereof (through a pyrometallurgical, hydrometallurgical approach, or a combination thereof) or for storage thereof. For example, it may consist of a temporary storage while waiting to transfer it, for example to a recycling plant to recover these different components.

For illustration, a recycling method may comprise the following steps: sorting, dismantling, opening according to the previously-described method, recycling by conventional means (pyrometallurgy, hydrometallurgy, . . . ).

Afterwards, the recoverable fractions of the electrochemical generator can be recovered and reused.

### ILLUSTRATIVE AND NON-LIMITING EXAMPLES OF ONE EMBODIMENT

### Opening a Cell with a Ceramic Blade in Ethaline-Medium

The ionic liquid solution is an Ethaline type ionic liquid mixture (mixture of choline chloride and ethylene glycol in a 1:2 ratio). The solution is dried to remove the water initially present at 2% by weight.

A 26650 Li-ion type cell is immersed in the ionic liquid solution. A zirconia-type ceramic blade is used to operate the opening action. Opening is done by penetration of the blade into the battery immersed in the ionic liquid solution with a controlled shock at 8 mm/s. The entire opening device is at room temperature and atmospheric atmosphere. The cutting action by an electrically non-conductive blade enables opening of the cell without explosion. After opening, the reaction between the lithium and the ionic liquid solution ensures both the discharge action and securing the cell. The cell has been neatly opened (FIG. 1) and can be treated without risk.

What is claimed is:

1-10. (canceled)

11. A method for opening an electrochemical generator comprising a negative electrode containing lithium or sodium and a positive electrode, the method comprising the following successive steps:
a) immersing the electrochemical generator in an ionic liquid solution comprising a solvent ionic liquid,
b) opening the electrochemical generator with an electrically-insulating element, opening being carried out in the ionic liquid solution.

12. The method according to claim 11, wherein the positive electrode contains lithium or sodium.

13. The method according to claim 11, wherein the ionic liquid solution further comprises a so-called oxidant redox species able to be reduced on the negative electrode so as to discharge the electrochemical generator.

14. The method according to claim 13, wherein the ionic liquid solution comprises the so-called oxidant redox species and a second so-called reductant redox species able to be oxidised on the positive electrode, the so-called oxidant redox species and the so-called reductant redox species forming a pair of redox species.

15. The method according to claim 14, wherein the pair of redox species is a metallic pair, a pair of organic molecules, a pair of metallocenes or a pair of halogenated molecules.

16. The method according to claim 15, wherein the pair of redox species is a metallic pair selected from among Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

17. The method according to claim 15, wherein the pair of redox species is a pair of metallocenes being Fc/Fc⁺.

18. The method according to claim 15, wherein the pair of redox species is a pair of halogenated molecules selected from Cl₂/Cl⁻ or Cl⁻/Cl₃₋.

19. The method according to claim 11, wherein the ionic liquid solution comprises an additional ionic liquid.

20. The method according to claim 11, wherein the ionic liquid solution forms a deep eutectic solvent.

21. The method according to claim 11, wherein the electrically-insulating element is a blade.

22. The method according to claim 21, wherein the blade is made of ceramic.

23. The method according to claim 11, wherein the electrically-insulating element is a jet of ionic liquid.

24. The method according to claim 23, wherein the jet of ionic liquid comprises electrically-insulating abrasive particles.

25. The method according to claim 11, wherein step b) is carried out in air or in an inert atmosphere.

26. The method according to claim 11, wherein it comprises, prior to step a), a step of dismantling or a step of sorting the generator.

27. The method according to claim 11, wherein it comprises, subsequent to step b), a storage step, a pyrometallurgical or hydrometallurgical step.
